(19) United States
(12) Patent Application Publication
(10) Pub. No.: US 2012/0115102 A1
(43) Pub. Date: May 10, 2012

(54) HYDRAULIC TOOTH CLEANER

(76) Inventor: Chun-Leon CHEN, Taipei City (TW)

(21) Appl. No.: 12/939,994

(22) Filed: Nov. 4, 2010

(51) Int. Cl. A61C 17/16

(52) U.S. Cl. 433/80

(57) ABSTRACT

A hydraulic tooth cleaner includes an upper tooth mold and a lower tooth mold respectively configured for attaching to the user's upper teeth and lower teeth, and a water press detachably connectable to nozzle tubes in a downward tooth groove in the upper tooth mold and an upward tooth groove in the lower teeth mold and controllable to supply a compressed fluid into the upper tooth mold and the lower tooth mold to clean the user's upper teeth and lower teeth.

### BACKGROUND OF THE INVENTION

1. Field of the Invention

The present invention relates to a cleaning apparatus for cleaning the teeth and more particularly, to a hydraulic tooth cleaner.

2. Description of the Related Art

When eating food, bits of food become lodged in and around the teeth. At this time, the food provides fuel for the bacteria in plaque. The bacteria produce acid that can break down the enamel surface of the teeth, leading to a cavity. Therefore, it is important to brush the teeth several times a day or after every meal.

Further, people may go to a dental clinic to clean the teeth regularly. A dentist can use a special cleaning tool, such as ultrasonic tooth cleaner, to clean the teeth. However, it is inconvenient and expensive to frequently visit a dentist for cleaning the teeth.

### SUMMARY OF THE INVENTION

The present invention has been accomplished under the circumstances in view. It is the main object of the present invention to provide a hydraulic tooth cleaner, which is inexpensive and practical for cleaning the teeth of a person safety, rapidly and effectively.

To achieve this and other objects of the present invention, a hydraulic tooth cleaner comprises a water press operable to supply a compressed fluid; an upper tooth mold attachable to the upper teeth of a user, the upper tooth mold comprising an upper mold boy defining a downward tooth groove configured for receiving the user's upper teeth and a plurality of protrusions symmetrically disposed in the downward tooth groove at two opposite sides corresponding to the gaps between the user's upper teeth, and a plurality of upper nozzle tubes respectively fastened to the upper mold boy and connected to the water press, each upper nozzle tube having an inner end disposed in fluid communication with the downward tooth groove and an outer end connectable to the water press; and a lower tooth mold attachable to the lower teeth of a user, the upper tooth mold comprising a lower mold boy defining an upward tooth groove configured for receiving the user's lower teeth and a plurality of protrusions symmetrically disposed in the upward tooth groove at two opposite sides corresponding to the gaps between the user's lower teeth, and a plurality of lower nozzle tubes respectively fastened to the lower mold boy and connected to the water press, each lower nozzle tube having an inner end disposed in fluid communication with the downward tooth groove and an outer end connectable to the water press.

When using the hydraulic tooth cleaner, attach the upper tooth mold and the lower tooth mold to the user's upper teeth and lower teeth, and then start up the water press to supply a compressed fluid to the upper and lower nozzle tubes into the upper tooth groove and the lower tooth groove to remove scale, tartar and dirt from the user's upper an lower teeth, causing scale, tartar and dirt to be gathered at the protrusions in the upper and lower tooth molds. After cleaning, remove the upper and lower tooth molds from the user's upper and lower teeth, and then wash away the gathered scale, tartar and dirt from the protrusions of the upper and lower tooth molds.

Subject to the application of the hydraulic tooth cleaner, a user can clean his (her) upper and lower teeth safely, rapidly and effectively.

### BRIEF DESCRIPTION OF THE DRAWINGS

FIG. 1 is a schematic view illustrating the arrangement of a hydraulic tooth cleaner in accordance with the present invention.

FIG. 2 is a plain view of the upper tooth mold of the hydraulic tooth cleaner in accordance with the present invention.

FIG. 3 is a schematic sectional view illustrating the upper tooth mold attached to the upper tooth of a person.

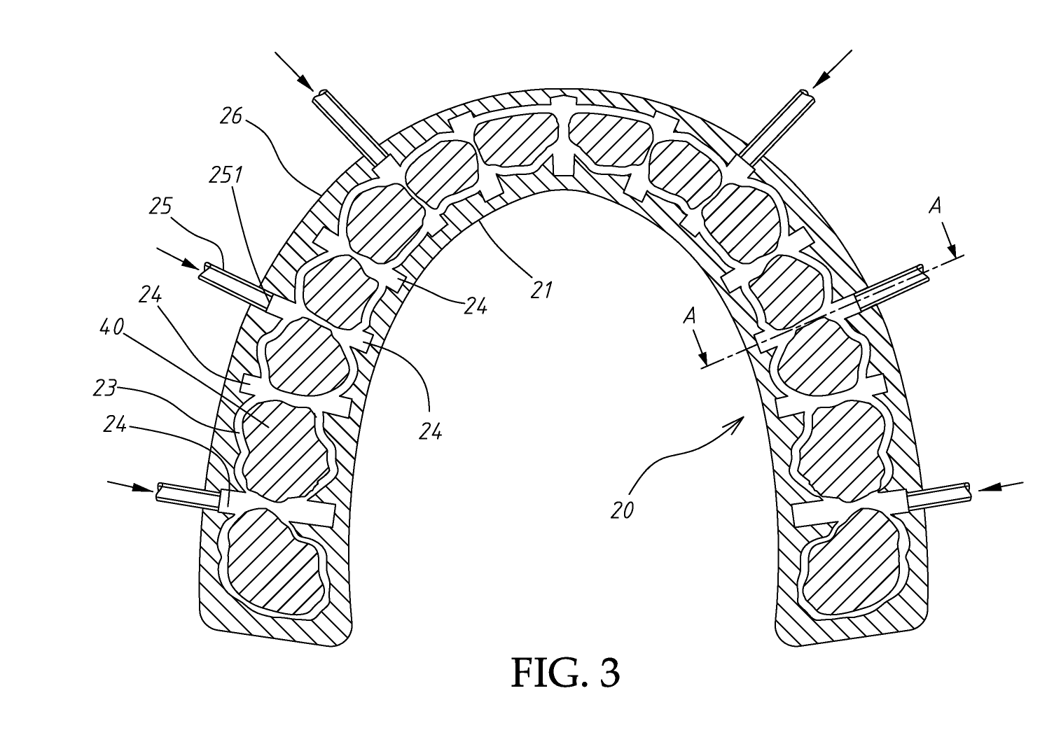

FIG. 4 is a sectional view taken along line A-A of FIG. 3.

### DETAILED DESCRIPTION OF THE PREFERRED EMBODIMENT

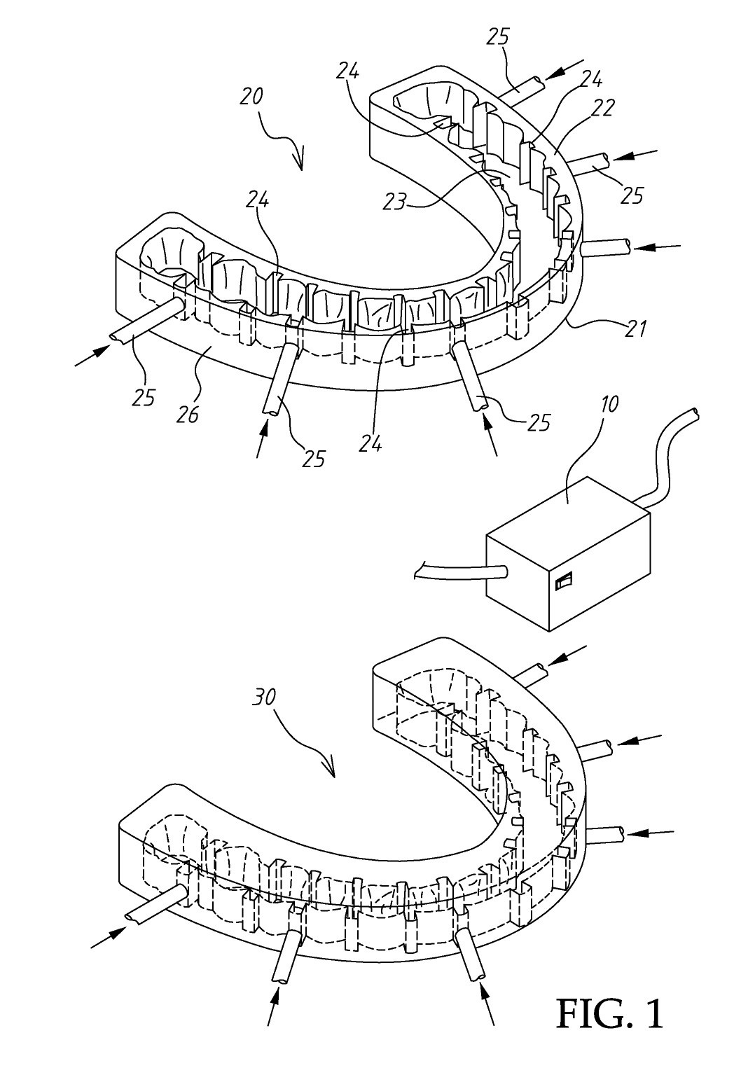

Referring to FIG. 1, a hydraulic tooth cleaner in accordance with the present invention is shown comprising a water press 10, an upper tooth mold 20, and a lower tooth mold 30.

The water press 10 is adapted to provide a compressed fluid.

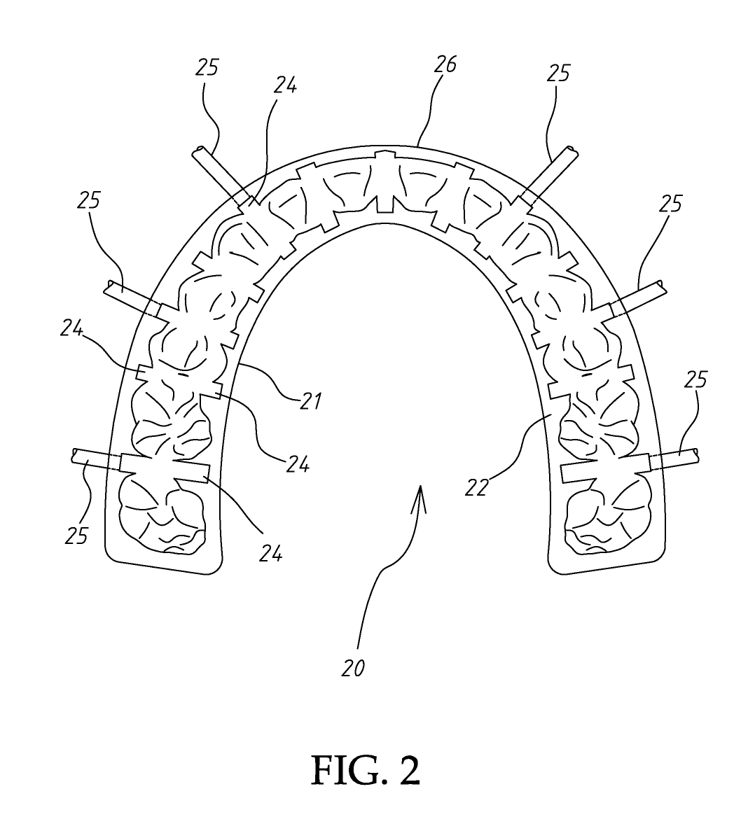

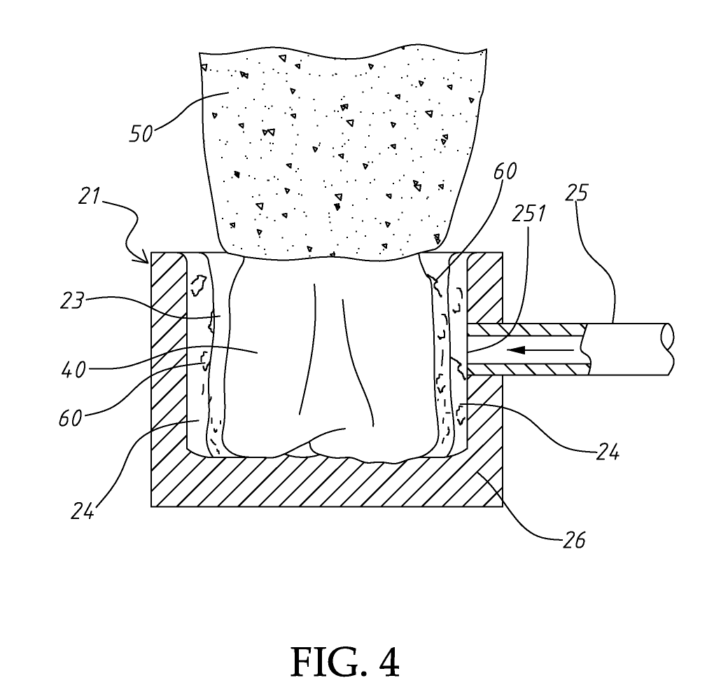

Referring to FIG. 2 and FIG. 1 again, the upper tooth mold 20 comprises an upper mold boy 21 defining a top wall 22, a front wall 26, a downward tooth groove 23 configured for receiving the upper teeth 40 of a person, and a plurality of protrusions 24 symmetrically disposed in the downward tooth groove 23 at two opposite sides corresponding to the gaps between the upper teeth 40, and a plurality of nozzle tubes 25 respectively fastened to the upper mold boy 21 and extending out of the front wall 26 of the upper mold body 21. The nozzle tubes 25 are respectively connected to the water press 10, each having an inner end 251 disposed in fluid communication with the downward tooth groove 23, as shown in FIG. 4. Thus, the water press 10 can be controlled to supply a compressed fluid into the nozzle tubes 25 and then the downward tooth groove 23 to remove scale, tartar and dirt 60 from the upper teeth 40.

The lower tooth mold 30 is substantially similar to the upper tooth mold 20 in structure with exception of the direction of its tooth groove.

When using the hydraulic tooth cleaner, attach the upper tooth mold 20 to the user's upper teeth 40, as shown in FIG. 4, to keep the top wall 22 in proximity to the user's upper gum 50, and then connect the nozzle tubes 25 to the water press 10, and then start up the water press 10 to supply a compressed fluid into the nozzle tubes 25 and then the downward tooth groove 23 in the illustrated arrowhead direction to remove scale, tartar and dirt 60 from the user's upper teeth 40. At this time, scale, tartar and dirt 60 will be gathered at the protrusions 24. After cleaning of the user's upper teeth 40, remove the upper tooth mold 20 from the user's upper teeth 40, and then wash away the gathered scale, tartar and dirt 60 from the protrusions 24 of the upper tooth mold 20. The use of the lower tooth mold 30 for cleaning the user's lower teeth is same as the use of the upper tooth mold 20 in cleaning the user's upper teeth.

Subject to the application of the hydraulic tooth cleaner, a user can clean his (her) upper and lower teeth safely, rapidly and effectively.

The upper tooth mold 20 and the lower tooth mold 30 can be prepared easily by attaching protruding objects to the gaps between the teeth prior to taking an impression in a dental clinic.

Further, the prepared upper tooth mold 20 and lower tooth mold 30 can be kept in the dental clinic for application. Alternatively, the user can keep the prepared upper tooth mold 20 and lower tooth mold 30 by oneself. When using the upper tooth mold 20 or the lower tooth mold 30, connect the upper tooth mold 20 or the lower tooth mold 30 to the water press 10, and then attach the upper tooth mold 20 or the lower tooth mold 30 to the user's upper teeth or lower teeth for cleaning operation.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A hydraulic tooth cleaner, comprising:
a water press operable to supply a compressed fluid;
an upper tooth mold attachable to the upper teeth of a user, said upper tooth mold comprising an upper mold boy defining a downward tooth groove configured for receiving the user's upper teeth and a plurality of protrusions symmetrically disposed in said downward tooth groove at two opposite sides corresponding to the gaps between the user's upper teeth, and a plurality of upper nozzle tubes respectively fastened to said upper mold boy and connected to said water press, each said upper nozzle tube having an inner end disposed in fluid communication with said downward tooth groove and an outer end connectable to said water press; and
a lower tooth mold attachable to the lower teeth of a user, said upper tooth mold comprising a lower mold boy defining an upward tooth groove configured for receiving the user's lower teeth and a plurality of protrusions symmetrically disposed in said upward tooth groove at two opposite sides corresponding to the gaps between the user's lower teeth, and a plurality of lower nozzle tubes respectively fastened to said lower mold boy and connected to said water press, each said lower nozzle tube having an inner end disposed in fluid communication with said downward tooth groove and an outer end connectable to said water press.
